(19) United States
(12) Patent Application Publication
(10) Pub. No.: US 2006/0096973 A1
(43) Pub. Date: May 11, 2006

(54) Coffee maker heating unit with dynamic temperature control responsive to the amount of coffee remaining in the carafe

(76) Inventor: Henry Jay Powell, Plano, TX (US)

Correspondence Address: Henry J. Powell, 9109 Roundbluff Road, Plano, TX, 75025, US

(21) Appl. No.: 10/983,423

(22) Filed: Nov. 8, 2004

(51) Int. Cl. H05B 3/68

(52) U.S. Cl. 219/447.1

(57) ABSTRACT

The object of this invention is the heating unit contained in electric coffee makers used to keep the coffee warm after it is brewed. This invention uses a scale or scale type mechanism to continuously measure the amount of coffee remaining in the carafe then continuously adjusts the temperature of the heating unit based on the amount of coffee remaining. This invention is designed to prevent or slow the degradation in the taste of coffee that results from over-cooking coffee through prolonged exposure to an excessive amount heat. The invention also includes calibration adjustments that permit fine-tuning of temperature to accommodate individual preferences and/or various types/brands of carafes.

### CROSS-REFERENCE TO RELATED APPLICATIONS

No claims to benefits of prior applications are made under this Specification.

### STATEMENT REGARDING FEDERALLY SPONSORED RESEARCH OR DEVELOPMENT

This invention is not the result of federally sponsored research.

### REFERENCE TO SEQUENCE LISTING, A TABLE, OR A COMPUTER PROGRAM LISTING COMPACT DISK APPENDIX

None

### BACKGROUND OF THE INVENTION

This invention relates to the heating unit (also known as the “hot-plate”) found in conventional drip coffee makers. The heating unit, for the purpose of this document, is defined as the heated surface upon which or adjacent to a carafe is situated for the purpose of heating the coffee within the carafe.

Conventional electric coffee-makers contain a heating unit or function designed to keep the coffee warm after the coffee is brewed. These heating units, however, do not have an effective mechanism for controlling the amount of heat applied to the carafe as the liquid (coffee) within the carafe is reduced, either through consumption or evaporation. As a result, the beverage in the carafe is often overheated resulting in a number of undesirable side-effects, such degradation of the taste/quality of the coffee and/or burning of the coffee (“burnt coffee).

Accordingly, the object of this invention is to dynamically regulate the amount of heat applied to the carafe by the heating unit as the volume of liquid in the carafe fluctuates.

The applicable U.S. patent Classification Definition for this invention includes, but is not limited to, class “99—Foods and Beverages: Apparatus,” subclasses “280—Automatic Control” and “281—Of Heat.”

This invention differs from other inventions in that the temperature of the heating unit (also know as the “keep warm function”) is controlled by the current amount of liquid in the carafe, not by the original amount of coffee brewed. Conventional coffee makers with adjustable “keep warm functions” adjust the heating unit temperature based on the amount of coffee originally brewed (1-4 cups or 5-10 cups). This invention adjusts the heating unit temperature as the volume of coffee changes.

### SUMMARY OF THE INVENTION

The object of this invention is the heating unit contained in electric coffee makers used to keep the coffee warm after it is brewed. This invention uses a scale or scale type mechanism to continuously measure the amount of coffee remaining in the carafe then continuously adjusts the temperature of the heating unit based on the amount of coffee remaining. This invention is designed to prevent or slow the degradation in the taste of coffee that results from over-cooking coffee through prolonged exposure to an excessive amount heat. The invention also includes calibration adjustments that permit fine-tuning of temperature to accommodate individual preferences and/or various types/brands of carafes.

### BRIEF DESCRIPTION OF THE SEVERAL VIEWS OF THE DRAWING

FIG. 1—A side cross-section view of a coffee maker for one possible configuration of the invention. In this configuration, the entire coffee maker is built upon a scale.

FIG. 2—A side cross-section view of a coffee maker for a second possible configuration of the invention. In this configuration, only the hot-plate component of the coffee maker is affixed to the scale.

### DETAILED DESCRIPTION OF THE INVENTION

Referring now to the two figures of the drawing, there is disclosed preferred embodiments of a coffee maker embodying the present invention. In referring to the figures of the drawing, like numerals shall refer to like parts.

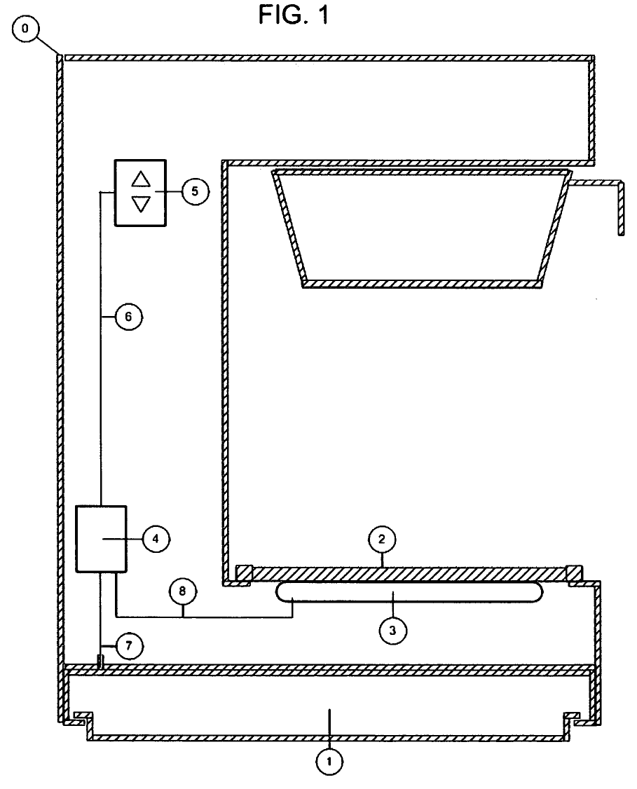

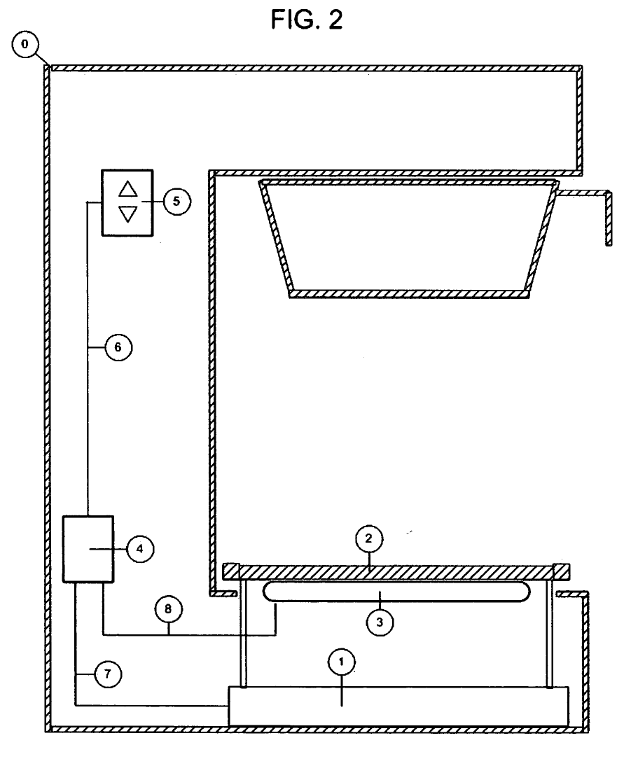

This invention pertains to the system for keeping coffee warm after it is brewed, and NOT to the system and components needed for brewing coffee. That said, FIGS. 1 and 2 omit those components of a coffee maker related to brewing and embody only those components germane to this invention. Referring now to FIGS. 1 and 2, there is shown a coffee maker (0) capable of brewing coffee, a scale (1), a hot-plate (2), a heating element (3), a logic unit (4), calibration controls (5), and the wiring (6, 7, and 8) necessary to connect these components.

Referring specifically to FIG. 1, the entire coffee maker (0) is built upon a scale (1) where the scale measures the weight of the entire coffee maker (0).

Referring specifically to FIG. 2, the hot-plate (2) is affixed to the scale (1).

Referring to FIGS. 1 and 2, the heating element (3) is affixed to the hot-plate (2). The logic unit (4) is connected to the scale (1) via wiring or other circuitry (7), and receives weight data from the scale (1). The logic unit (4) contains a thermostat capable of adjusting the amount of heat produced by the heating element (3) which is connected to the logic unit (4) via wiring other circuitry (8). The logic unit (4) is also connected to the calibration controls (5) via wiring or other circuitry (6). The calibration controls (5) allow a human to fine-tune the ratio of the change in heat to change in weight, within predefined upper and lower limits.

Referring specifically to FIG. 1, when water is added to the coffee maker (0) during the brewing cycle, the weight of the coffee maker (0) is increased by the weight of the water added to it. The scale (1) passes the weight data to the logic unit (4), via wiring or other circuitry (7), and the logic unit (4) detects the change in weight. The logic unit (4) uses an embedded algorithm (either via computer software and/or hardware or some other mechanism) to determine the appropriate thermostat setting. The logic unit (4), which is connected to the heating element (3) via wiring or other circuitry (8), adjusts the thermostat thereby altering the amount of heat produced by the heating element (3).

Referring specifically to FIG. 2, a carafe situated upon the hot-plate (2) is filled with coffee as a result of the brewing process. The scale (1) to which the hot-plate (2) is affixed is connected to the logic unit (4) via wiring or other circuitry (7), and passes weight data to the logic unit (4). The logic unit (4) detects the change in weight and uses an embedded algorithm (either via computer software and/or hardware or some other mechanism) to determine the appropriate thermostat setting. The logic unit (4), which is connected to the heating element (3) via wiring or other circuitry (8), adjusts the thermostat thereby altering the amount of heat produced by the heating element (3).

Referring to FIGS. 1 and 2, brewed coffee is housed in a carafe which sets upon the hot-plate (3). Fluctuations in the amount of coffee result in fluctuations in the amount of weight applied to the scale (1). If additional coffee is brewed, the weight applied to the scale increases. The logic unit (4) detects this change and increases the amount of heat produced by the heating element (3). As coffee is removed, either through consumption or evaporation, less weight is applied to the scale (1). The logic unit (4) detects the reduced weight and adjusts the thermostat, thus reducing the amount of heat produced by the heating element (3).

I claim the following:

1. An improvement upon conventional electric coffee makers in which a scale and a logic unit are built into the coffee maker and are used to dynamically adjust the amount of heat produced by the coffee maker's hot-plate heating element in order to prolong the taste quality of coffee.

2. The improvement according to claim 1 contains a scale connected to a logic unit.

3. The logic unit defined in claim 1 receives weight data from the scale and applies an algorithm to the weight data to determine the appropriate thermostat setting based on the amount of weight.

4. The logic unit defined in claim 1 is connected to the coffee maker's hot-plate heating element, and dynamically adjusts the amount of heat produced by the heating element as the amount (determined by weight) of coffee changes.

5. The improvement according to claim 1 includes calibration controls connected to the logic unit that allow a person to fine-tune the ratio between change in heat and amount (as determined by weight) of coffee remaining.
